(19) United States
(12) Patent Application Publication
(10) Pub. No.: US 2017/0057407 A1
(43) Pub. Date: Mar. 2, 2017

(54) Courtesy Light

(71) Applicants: Johnny Ray Gee, Wichita Falls, TX (US); Cynthia Laraine Gee, Wichita Falls, TX (US)

(72) Inventors: Johnny Ray Gee, Wichita Falls, TX (US); Cynthia Laraine Gee, Wichita Falls, TX (US)

(21) Appl. No.: 14/837,301

(22) Filed: Aug. 27, 2015

(51) Int. Cl. B60Q 1/50; B60Q 1/00; B60R 13/00

(52) U.S. Cl. CPC B60Q 1/503; B60R 13/005; B60Q 1/0088

(57) ABSTRACT

A device to display vehicle courteous message has been disclosed. The device, vehicle courteous message display is devised to display the driver's response. It includes a frame that has a display, to display courteous messages such as “Thank You”, connected to an internal electrical circuit within the vehicle, powered on/off using a switch provided at driver's end. The display panel is placed at the rear end of the trailer attached to vehicles or at rear end of vehicles.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to the field of accessories for the vehicle, and more particularly it relates to a courtesy light for truck trailer.

(2) Background of the Invention

The lighting system of a motor vehicle consists of lighting and signaling devices mounted or integrated to various parts of a motor vehicle. These may include the front, sides, rear and, in some cases, the top of the vehicle. The purpose of this system is to provide illumination for the driver. This enables safe vehicle operation after dark and increases the conspicuity of the vehicle. The lighting system allows other drivers and pedestrians to observe the vehicle's presence, position, size, direction of travel, and the driver's intentions regarding direction and speed of travel. Emergency vehicles may carry distinctive lighting equipment to warn drivers and indicate priority of movement. Accordingly, courtesy lights were also developed. Courtesy Lights are used to request right-of-way primarily by volunteer or call firefighters and emergency medical technicians (EMTs) to expedite their drive in their privately owned vehicles, to their firehouse or base. Courtesy lights do not allow the user to disobey traffic laws such as speed limit, stop signs or stop lights.

Drivers of the trucks with trailers have their vision partially blocked by the body of trailer of other vehicles. In order to maintain the smooth flow of the traffic, trucks typically use the right hand lane of the road except when passing or turning. Usually, when a large truck passes another vehicle, the driver tends to return to the right hand lane as quickly as possible. A courteous driver will flash headlights for few seconds or will put lights from low beam to high beam to alert the truck driver that it is safe for the truck to return to the right hand lane. Similarly, as a return courtesy, another driver will flash the trailer lights as a thank you for the driver giving indications.

Many prior arts have shown such kind of lighting system in different forms such as messages to guide the truck drivers to drive safely. Like, prior art, U.S. Pat. No. 5,825,281 A; U.S. Pat. No. 7,696,865 B1; US 20060232986 A1; U.S. Pat. No. 4,868,542 A and U.S. Pat. No. 6,688,027 B2 have disclosed different kind of message boards to be attached to the trailer of the vehicle including message to be displayed on application of brakes; electronic message board for vehicles; display device controlled through a switch; automobile signaling system on application of brakes and selectively reversible message boards are also available to be attached to the trailer of the vehicle.

Various other prior arts, Patent No US 20140043156 A1, US 20140267975 A1; U.S. Pat. No. 6,858,986 B2; U.S. Pat. No. 6,809,654 B2; U.S. Pat. No. 4,860,476 A; US 20030140536 A1 discloses similar kind of tailgate of vehicles with lighted display or lighted message boards to courteously guide the drivers and ensure smooth running of traffic. Prior arts such as Patent No U.S. Pat. No. 5,119,278 A and US 20050083183 A1 discloses vehicle courteous message display designed to express a driver's response when the need arises.

It would therefore be advantageous to provide both a means for lighting the interior of a transit vehicle or conveyance and a means for displaying information or advertisements to passengers or others, which overcomes one or more of the disadvantages or limitations of conventional lighting systems, printed advertisements, and/or electronic displays or messages.

### SUMMARY OF THE INVENTION

In view of the foregoing applications inherent in the known types of courtesy lights present in the prior art, the present invention provides improved courtesy lights provided for installing on the rear end of the trailer of the truck or other such big vehicles to pass courteous messages to fellow drivers while driving to ensure smooth sailing of the. As such, the general purpose of the present invention, which will be described subsequently in greater detail, is to provide improved message flashing courtesy lights which has all the advantages of the prior art and none of the disadvantages.

Accordingly, it is an aspect of the present invention to provide courtesy light flashing messages to be installed at the back of the trailer that is connected to long vehicles like trucks to easily overtake the passing vehicle and further flash the courtesy message in response to thank the driver of the passed vehicle to allow him to overtake the same.

It is an object of the present invention to provide courtesy light flashed as a message to be mounted at the trailing end of the truck or large vehicle.

It is also an object of the present invention to provide LED containing flashing courtesy lights on the rear end of the vehicle that will be wired into turn signal light or as a separate switch activated by the driver.

It is another object of the present invention to provide an automobile sign that affords clear and colorful messages that can be seen in day and night.

Further it is an object of the present invention to provide courtesy lights that is economical, energy efficient and light in weight.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a perspective view of the present invention.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

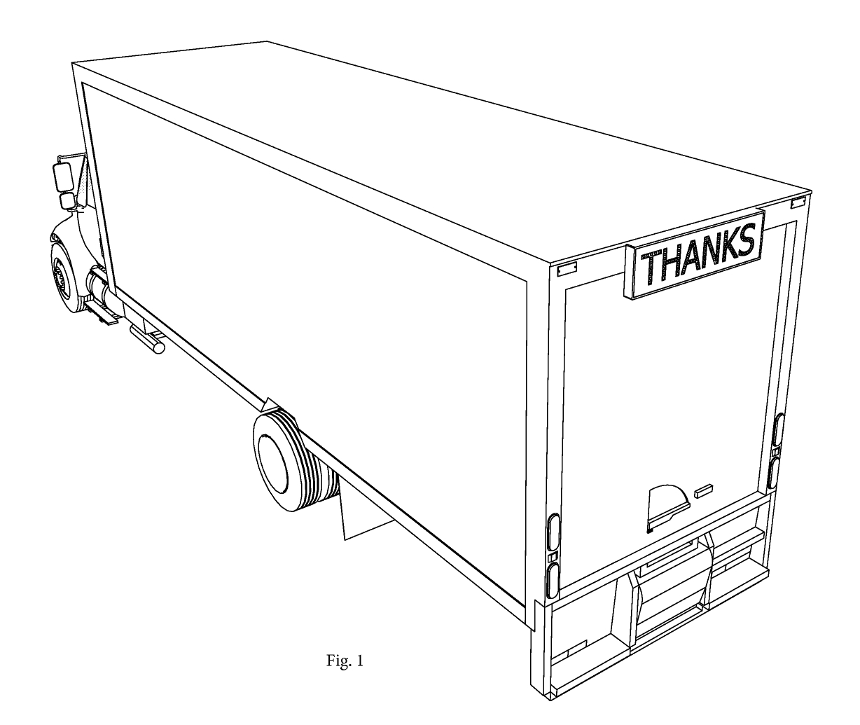

Referring to FIG. 1 the present invention discloses “Thanks” courtesy lights to be installed on the rear end of the vehicle, powered by electrical circuit that is further connected internally to a switch to power on/off the system at the driver's end. Courtesy lights are arranged in a manner to flash “Thanks” message once the vehicle passes by. In its preferred embodiment, the present invention provides selectively message flashing courtesy lights to be used when the driver of a large vehicle or truck with trailer is willing to change the lane by informing the passing vehicle through the courtesy lights and flashing them again once the driver has reached the right lane to thank the driver of the passed vehicle as a courteous message.

The invention is a display for use on automobiles or other modes of transportation. The display is clear with an electro surface, provided to be display where required, utilizes the power form the electrical setup in the interior of the vehicle, provided with an on/off switch at the driver's end for easy operation. In another preferred embodiment, the present invention is 14 inches long, 4¼ inches tall and 1¾ inches wide with an approximately weight of 1 pound. The lights used are made of aluminum and lens is made of acrylic material.

The present invention provides advantageous features over the conventional lighting devices that includes the courteous lights minimizes the chances of occurrence of an accident by not obstructing other drivers, traffic is able flow more smoothly and there is less tail-gaiting, less weaving in and out of traffic and therefore fewer accidents; better gas mileage as lane courtesy promotes the smooth flow of traffic and help drivers maintain an even pace; destination will be reached faster as yielding to faster traffic reduces congestion because when traffic is flowing smoothly, highway capacity can be utilized to the fullest extent; no dealing with road rage as there will be no left lane hogs which acts as a source of irritation for many drivers. The courteous act of moving to the right lane can eliminate driver stress and conflict.

Although the invention has been explained in relation to its preferred embodiment, it is to be understood that many other possible modifications and variations can be made without departing from the spirit and scope of the invention.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

1. A system for flashing a message at a rear of a vehicle, the system comprising:
a display for displaying the message, the display being configured to be coupled to an internal circuitry of the vehicle; and
a means for illuminating said message in the display; wherein,
a power supply to said illuminating message is received from the vehicle and is configured to be controlled via a switch located near an operator of said vehicle.

2. The display system according to claim 1, wherein said message is a courteous message and is visible for a driver being passed.

3. The system according to claim 1, wherein said message is one of “Thanks,” and “Thank You” and is visible for a driver being passed.

4. The system according to claim 1, wherein the display for displaying said message comprises a frame structure.

5. The system according to claim 1, wherein said means for illuminating said message is an electrically powered light source.

6. The system according to claim 5, wherein said electrically powered light source comprises a plurality of light emitting diodes (LEDs).

7. The system according to claim 6, wherein the display is coupled to an internal circuitry of the vehicle via wires or cables.

8. The system according to claim 7, wherein the internal circuitry of the vehicle is a circuitry for turn light signal and the switch is an on/off switch.

9. (canceled)

10. The system according to claim 6, wherein the plurality of light emitting diodes (LEDs) are red light emitting diodes.

11. The system according to claim 10, wherein the display is 14 inches long, 4¼ inches tall and 1¾ inch wide.

12. The system according to claim 11, wherein the display is about 1 pound.

13. A display tor flashing a message at a rear of a vehicle, wherein,
the display is configured to be coupled to an internal circuitry of the vehicle and
power to the display is received from the vehicle and is configured to be controlled via a switch located near an operator of said vehicle to control the illumination of the message in the display.

14. The system according to claim 13, wherein the internal circuitry of the vehicle includes a circuitry for turn light signal.
